(19) United States
(12) Patent Application Publication
(10) Pub. No.: US 2025/0347663 A1
(43) Pub. Date: Nov. 13, 2025

(54) FIELD FLOW FRACTIONATION AND SIZE-EXCLUSION CHROMATOGRAPHY SWITCHING

(71) Applicant: Wyatt Technology, LLC, Goleta, CA (US)

(72) Inventors: Steven P. Trainoff, Santa Barbara, CA (US); Erasums Volz, Lake Stevens, WA (US)

(21) Appl. No.: 19/200,951

(22) Filed: May 7, 2025

Related U.S. Application Data
(60) Provisional application No. 63/644,159, filed on May 8, 2024.

(51) Int. Cl. G01N 30/00; G01N 30/24; G01N 30/32

(52) U.S. Cl. CPC G01N 30/0005; G01N 30/24; G01N 30/32; G01N 2030/0025; G01N 2030/328

(57) ABSTRACT

A fractionation system includes a solvent delivery system, a sample delivery system, a field flow fractionation (FFF) system including pressure-sensitive components and a FFF channel, the FFF channel fluidically connected to the sample delivery system and the solvent delivery system, a size exclusion chromatography (SEC) system including a chromatography column, the chromatography column fluidically connected to the sample delivery system and the solvent delivery system, and a switching system for switching between a field flow fractionation (FFF) mode in which the FFF channel is active to a size exclusion chromatography (SEC) mode in which the chromatography column is active, where the pressure-sensitive components of the FFF system are fluidically isolated during the SEC mode.

### RELATED APPLICATION

This application claims priority to U.S. provisional patent application No. 63/644,159 filed May 8, 2024 and titled “Field Flow Fractionation and Size-Exclusion Chromatography Switching” the entirety of which is incorporated by reference herein.

### FIELD OF THE INVENTION

The disclosed technology generally relates to a device and method for switching between field flow fractionation (FFF) and high-pressure liquid chromatography (HPLC), and more particularly high pressure size-exclusion chromatography (SEC) applications. More particularly, the technology relates to a device and method for performing FFF that can also accommodate fast and immediate switching to HPLC.

### BACKGROUND

Mass flow controllers (MFCs), such as the Bronkhorst® CORI-FLOW™ Mass Flow Meter, used in these present field flow fractionation FFF systems have internal components that limit the operating pressure of the instrument. These mass flow controllers contain a Coriolis flow meter and a proportional control valve. The proportional control valve (in an open state) and the Coriolis flow meter each have a burst pressure around 150 bar. Further, the proportional control valve can only accommodate a differential pressure of around 30 bar when the proportional control valve is closed or used for flow regulation. Thus, in FFF mode when the proportional control valve is used for flow regulation, the system monitors the channel pressure and stops the flow (with an alarm) if the pressure approaches the 30 bar maximum.

It has become desirable in the art of fractionation to produce FFF systems which can switch between FFF mode, in which the sample is fractionated by a channel, and HPLC and/or SEC mode in which the sample is fractionated by a column. However, in HPLC and/or SEC mode it is common to run the columns at much higher pressures (e.g., over 150 bar) than the pressures of FFF operation. At these higher SEC pressures, the system components of the Coriolis flow controllers would exceed burst pressures.

Therefore, devices and methods for switching between FFF and HPLC capable of operating the HPLC at higher pressures (e.g., over 50 bar) would be well received in the art.

### SUMMARY

In one aspect, a fractionation system includes a solvent delivery system, a sample delivery system, a field flow fractionation (FFF) system including pressure-sensitive components and a FFF channel, the FFF channel fluidically connected to the sample delivery system and the solvent delivery system, a size exclusion chromatography (SEC) system including a chromatography column, the chromatography column fluidically connected to the sample delivery system and the solvent delivery system, and a switching system for switching between a field flow fractionation (FFF) mode in which the FFF channel is active to a size exclusion chromatography (SEC) mode in which the chromatography column is active. The pressure-sensitive components of the FFF system are fluidically isolated during the SEC mode.

Additionally or alternatively, the SEC mode is configured to operate above 150 bar pressure without damaging the pressure-sensitive components of the FFF system.

Additionally or alternatively, the SEC mode is configured to operate up to at least 400 bar pressure without damaging the pressure-sensitive components of the FFF system.

Additionally or alternatively, the switching system includes a 10 port rotary switching valve, which may be fluidically coupled to a manifold.

Additionally or alternatively, the fractionation system includes a 6-port rotary switching valve fluidically coupled to the manifold and the 10-port rotary switching valve.

Additionally or alternatively, the 10-port first rotary switching valve is configured to switch between the FFF mode and the SEC mode, and wherein a second 6-port rotary switching valve is configured to switch between a focus mode and an elute mode during the FFF mode.

Additionally or alternatively, the fractionation system further includes an inlet pressure sensor coupled to the solvent delivery system.

Additionally or alternatively, the pressure-sensitive components include at least one flow controller, which may include a Coriolis flow meter and a proportional control valve.

Additionally or alternatively, the sample delivery is an autosampler, and wherein the switching system includes impedance tubing configured to drive a sample from a mass flow controller to the autosampler in FFF mode.

In another aspect, a fractionation method includes providing a fractionation system including a solvent delivery system, a sample delivery system, a field flow fractionation (FFF) system including pressure-sensitive components and a FFF channel, a size exclusion chromatography (SEC) system including a chromatography column, and a switching system. The fractionation method further includes switching, by the switching system, between a field flow fractionation (FFF) mode in which the FFF channel is active to a size exclusion chromatography (SEC) mode in which the chromatography column is active, fluidically isolating the pressure-sensitive components of the FFF system during the SEC mode.

Additionally or alternatively, the fractionation method further includes operating above 150 bar pressure, and/or 400 bar pressure, without damaging the pressure-sensitive components of the FFF system during the SEC mode.

Additionally or alternatively, the switching system includes a 10-port rotary switching valve and a 6-port rotary switching valve, and the method further includes switching between a FFF mode and a SEC mode with the 10-port rotary switching valves, and/or switching between a focus mode and an elute mode during the FFF mode with the 6-port rotary switching valve.

Additionally or alternatively, the sample delivery is an autosampler, and the method further includes generating the pressure that pushes a sample from a mass flow controller to the autosampler in FFF mode with impedance tubing.

Additionally or alternatively, the chromatography column is a high performance column, and the method further includes separating a sample through the high performance columns at pressures over 150 bar in SEC mode.

In another aspect, a fractionation system includes a switching valve system including a 10-port rotary switching valve and a 6-port rotary switch valve. The switching valve system is coupled to a switch actuator for a field flow fractionator (FFF) system in order to isolate pressure-sensitive components of the FFF system in a high-pressure liquid chromatography (HPLC) mode, and the switching system further includes impedance tubing to drive a sample from an autosampler in an FFF mode. The fractionation system further includes a manifold coupled to the switching valve system, and a union coupled to the switching valve system and the manifold. The switching valve system, the manifold, the union, and the switch actuator enable separating the sample through high performance columns at pressures over 75 bar in HPLC mode.

Additionally or alternatively, fractionation system includes a pump; and an inlet pressure sensor coupled to the switching valve system and the pump.

Additionally or alternatively, the fractionation system includes a control system. The control system is configured to stop the pump if the inlet pressure sensor detects over-pressure.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic fluidic diagram of a field flow fractionation (FFF) and size-exclusion chromatography (SEC) system, in accordance with one embodiment.

FIG. 2 depicts a schematic fluidic diagram of a field flow fractionation (FFF) and size-exclusion chromatography (SEC) system in SEC mode where darkened lines indicate a fluid flow path, in accordance with one embodiment.

FIG. 3 depicts a schematic fluidic diagram of another field flow fractionation (FFF) and size-exclusion chromatography (SEC) system having a manifold apparatus that simplifies the plumbing, in accordance with one embodiment.

FIG. 4A depicts a schematic fluidic diagram of the FFF and SEC system of FIG. 1 in FFF focus mode, in accordance with one embodiment.

FIG. 4B depicts a schematic fluidic diagram of the FFF and SEC system of FIGS. 1 and 2 in FFF focus mode during injection, in accordance with one embodiment.

FIG. 4C depicts a schematic fluidic diagram of the FFF and SEC system of FIGS. 1-3 in FFF elution mode with dilution control, in accordance with one embodiment.

FIG. 4D depicts a schematic fluidic diagram of the FFF and SEC system of FIGS. 1-4 in FFF elution mode during injection with dilution control, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

### Definitions

Hereinafter, “particle” means a constituent of a liquid sample aliquot. Particles may be molecules of varying types and sizes, nanoparticles, virus like particles, liposomes, emulsions, bacteria, and colloids. Particles may range in size on the order of nanometer to micrometer.

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

Hereinafter, “Field Flow Fractionation” (or FFF) means the separation of particles in a solution by means of field flow fractionation, FFF, was studied and developed extensively by J. C. Giddings beginning in the early 1960s. The basis of these techniques lies in the interaction of a channel-constrained sample and an impressed field applied perpendicular to the direction of flow. There are several variations of this technique including asymmetric flow FFF (i.e., A4F), and hollow fiber (H4F) flow separation. Further FFF techniques include cross flow FFF, often called symmetric flow (SFIFFF), where an impressed field is achieved by introducing a secondary flow perpendicular to the sample borne fluid within the channel.

Other FFF techniques include (i) sedimentation FFF (SdFFF), where a gravitational/centrifugal cross force is applied perpendicular to the direction of the channel flow, (ii) electrical FFF (EFFF), where an electric field is applied perpendicular to the channel flow, and (ii) thermal FFF (ThFFF), where a temperature gradient is transversely applied.

Common to all these methods of field flow fractionation is a fluid, or mobile phase, into which is injected an aliquot of a sample whose separation into its constituent fractions is achieved by the application of a cross field. Many of the field flow fractionators allow for the control and variation of the strength of the cross field during the time the sample aliquot flows down the channel, be it electrical field, cross flow, thermal gradient, or other variable field.

Hereinafter, “size exclusion chromatography” (SEC) means a chromatographic method in which a chromatography column is used to separate particles by particles size. SEC is sometimes referred to as gel filtration. During SEC, separation occurs when molecules of different sizes are included or excluded from the pores within the matrix of the chromatography column with larger sized species of particles eluting before smaller. SEC is typically performed at higher pressures than FFF.

Hereinafter, “reverse phase chromatography” means a mode of liquid chromatography in which non-polar stationary phase and polar mobile phases are used for the separation of organic compounds. Reverse phase chromatography may include high-performance chromatography (HPLC) at high pressures.

Hereinafter, “high-pressure liquid chromatography” means any chromatography, such as SEC and reverse phase chromatography, which utilizes operating pressures of 50 bar or more. Specifically HPLC may include both SEC, reverse phase chromatography, or any type of chromatography in which operational pressures exceed 50 bar. Often, high-pressure liquid chromatography is performed at pressures well over 50 bar, and can include operational pressures of 100-400 bar or more.

Hereinafter, “pressure-sensitive components” means components which are designed for low pressure FFF implementations, which usually includes operating pressures within the 30-50 bar range. Pressure-sensitive components include low flow Coriolis mass flow meters, and may include flow meters, proportional control valves and the like. Pressure-sensitive components may have pressure limits of 75 bar and/or pressure limits at or below 100 bar. Pressure-sensitive components may not generally be compatible with SEC applications, which often have operating pressures of 150 bar or more. Examples of pressure-sensitive components include but are not limited to the Bronkhorst® CORI-FLOW™ Mass Flow Meters and Controllers.

### Current Technologies

Known FFF systems have been adapted to perform SEC separations with a chromatography column, as described in U.S. Patent Publication No. 2022/0212123A1. However, current dual systems capable of switching between FFF mode to SEC mode are limited in the operational pressures while in SEC mode. This is because of the pressure-sensitive components found in the FFF system are fluidically connected and subject to pressures in SEC mode, and often have limiting burst pressures. Prior to the concepts described herein, complete isolation of all the pressure-sensitive components of the FFF system during SEC mode using current technology is not possible. With partial isolation of current technologies using a solenoid isolation valve, current technologies can operate safely up to 75 bar during SEC mode with an engineering safety margin. However, the injection controller in these current systems is still subject to channel pressure and thereby limits the system.

Thus, there is a need to manage solvent associated with a FFF system that can also operate under SEC mode at high pressures over 75 bar without damaging the pressure-sensitive components of the FFF system.

FFF and SEC Systems with Isolation of Pressures-Sensitive Components

In brief overview, embodiments and examples disclosed herein are directed to a system for performing both field flow fractionation (FFF) and size-exclusion chromatography (SEC). In particular, the system is adapted for switching between FFF and higher-pressure SEC applications by isolating pressure sensitive controls of the FFF system which would otherwise be damaged during high pressure SEC. Thus, embodiments described herein can perform FFF and can switch to an SEC mode which accommodates pressures over 150 bar, or even higher. Embodiments described herein accomplish this switching by incorporating a 10-port rotary switching valve in combination with a 6-port rotary switching valve. This switching system allows for operation of the SEC system at high pressures while isolating and protecting the pressure-sensitive FFF components.

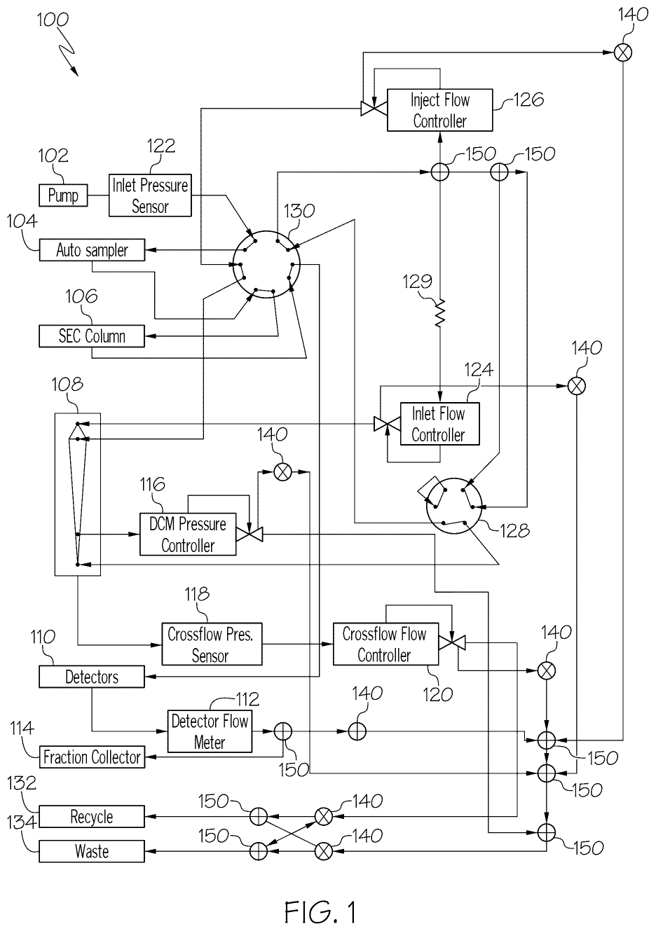

FIG. 1 depicts a schematic fluidic diagram of a field flow fractionation (FFF) and size-exclusion chromatography (SEC) system, in accordance with one embodiment. The FFF and SEC system 100 includes a pump system 102, an auto sampler 104, an SEC column 106, a field flow fractionator channel 108, one or more detectors 110, a detector flow meter 112, and an optional fraction collector 114. Still further, the FFF and SEC system 100 includes an FFF dilution pressure controller 116, a FFF cross flow pressure sensor 118, and a FFF cross flow controller 120. The system 100 further includes an inlet pressure sensor 122, an inlet flow controller 124, and an inject flow controller 126. The inlet pressure sensor 122 may be operably connected to a control system (e.g., a computer system, not shown) and may be used for safety. The inlet pressure sensor 122 may ensure that the impedance tubing, back pressure regulators, and solvent filters are operating at acceptable pressure levels. The control system may be configured to stop the pump 202 if the inlet pressure sensor 122 detects over-pressure.

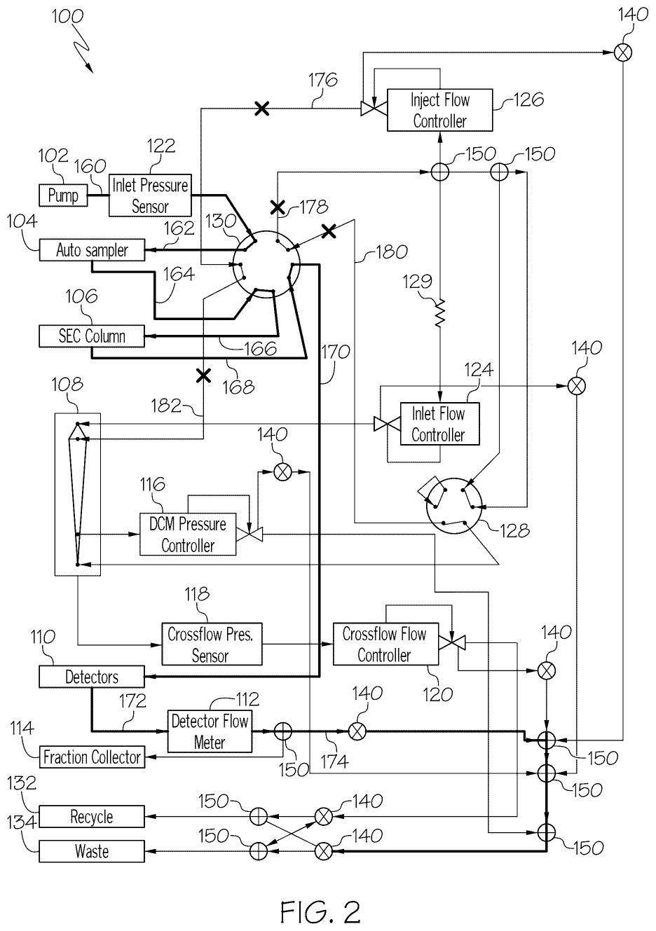

The FFF and SEC system 100 includes a 6-port rotary switching FFF focus/elute valve 128. In addition, the FFF and SEC system 100 includes a 10-port rotary switching valve 130 configured to isolate the pressure sensitive components during the higher-pressure SEC mode, as described herein below. These valves 128, 130 provide for the FFF and SEC system 100 to switch between SEC mode, FFF focus mode, FFF focus mode during injection, FFF elution mode with dilution control, and FFF elution mode during injection with dilution control. Further, during the SEC mode (shown in FIG. 2), the various pressure-sensitive components of the FFF are isolated by the 10-port rotary switching valve 130 and are therefore not subject to pressure, thereby protecting these components from pressure damage. In other words, the valve 130 switches between SEC and FFF mode, while the valve 128 is used in FFF mode to switch between FFF focus and FFF elution. The valve 128 is not used when the valve 130 is in SEC mode.

Further, the FFF and SEC system 100 includes impedance tubing 129 located proximate the inject flow controller 126. In particular, the impedance tubing 129 is located between the inlet flow controller 124 and the inject flow controller 126. The impedance tubing 129 may be configured to generate injection pressure so that a sample is pushed and will flow from a mass flow controller (i.e. inject flow controller 126) to the autosampler 104 and to the channel inlet in FFF mode.

The FFF and SEC system 100 further includes various solenoid valves 140 and unions 150. While the various solenoid valves 140 and unions 150 are all shown with the same numerical label, the actual component may or may not be the exact same component and/or share the properties (e.g., type, size, inner diameters, pressure ratings, flow rates, etc.). These components 140, 150 are used to purge the mass flow controller valves when the solvent is changed, or to eliminate trapped bubbles. Moreover, the FFF and SEC system 100 includes a recycle fluid path 132 and a waste fluid path 134.

FIG. 2 depicts a schematic fluidic diagram of a field flow fractionation (FFF) and size-exclusion chromatography (SEC) system 100 in SEC mode, in accordance with one embodiment. In this embodiment, the 10-port rotary switching valve 130 is shown in a state in which fluidic pathways 160, 162, 164, 166, 168, 170, 172, 174 are opened for performing SEC and channeling a sample and/or solvent through the SEC column 106 and then to the detector 110. In this state, the 10-port rotary switching valve 130 ensures that various fluidic pathways 176, 178, 180, 182 are isolated, closed off and/or not subject to the pressure created by the activity of the pump system 102.

In the SEC mode as shown, a solvent is pumped by the pump system 102 through a fluidic channel 160 coupling the pump 102 to the 10-port rotary switching valve 130. The pump system 102 may be any kind of appropriate pump system and/or solvent delivery system for pumping and/or delivering solvent into the FFF and SEC system 100. The fluidic channels described herein may be any type of fluidic line with any appropriate internal diameters to appropriately transfer the flows of solvent and/or sample.

The 10-port rotary switching valve 130 couples the solvent to the autosampler 104 by a fluidic channel 162. The fluidic channel 162 transports the solvent from the 10-port rotary switching valve 130 to the autosampler 104. The auto sampler 104 may be any type of sample management and/or delivery system that is configured to inject a sample into the flow of solvent.

From the auto sampler 104, the solvent and sample combination is directed back to the 10-port rotary switching valve 130 via a fluidic channel 164. The 10-port rotary switching valve 130 is also coupled to the SEC column 106 via a fluidic channels 166 and 168. The solvent and sample combination is provided to the SEC column 106 from the 10-port rotary switching valve 130 via the fluidic channel 166 and returns via the fluidic channel 168.

The 10-port rotary switching valve 130 is further coupled to one or more detectors 110 via fluidic channel 170. After returning to the 10-port rotary switching valve 130 from the SEC column via fluidic channel 168, the solvent and sample is then provided to the one or more detectors 110 via the fluidic channel 170. A fluidic channel 172 further connects the one or more detectors 110 to a downstream detector flow meter 112.

From the detector flow meter 112, the solvent and sample combination may be provided to either the fraction collector 114 or to the recycle fluid path 132 and/or the waste fluid path 134 via a fluidic path 174.

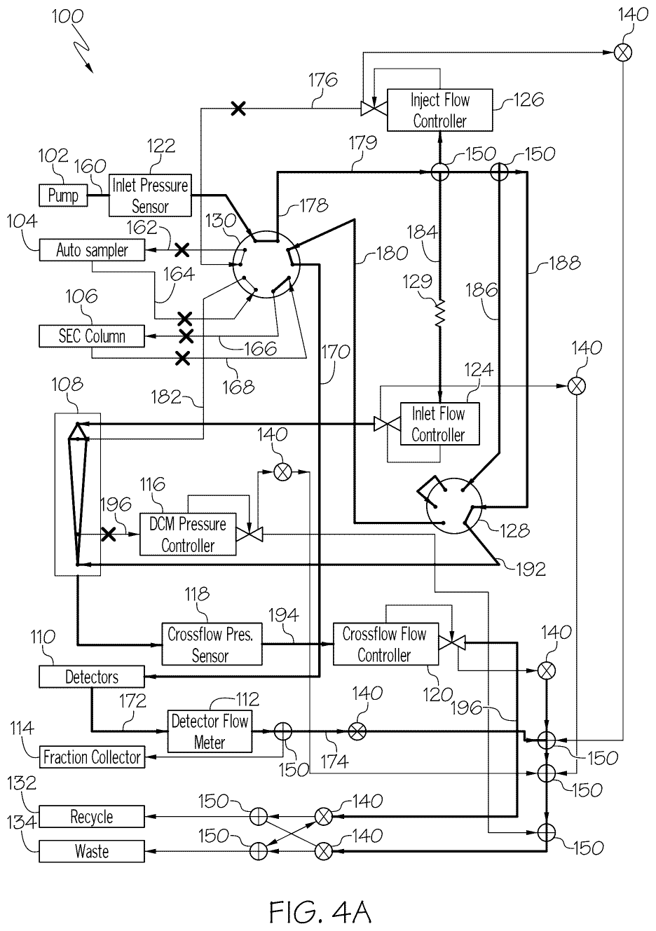

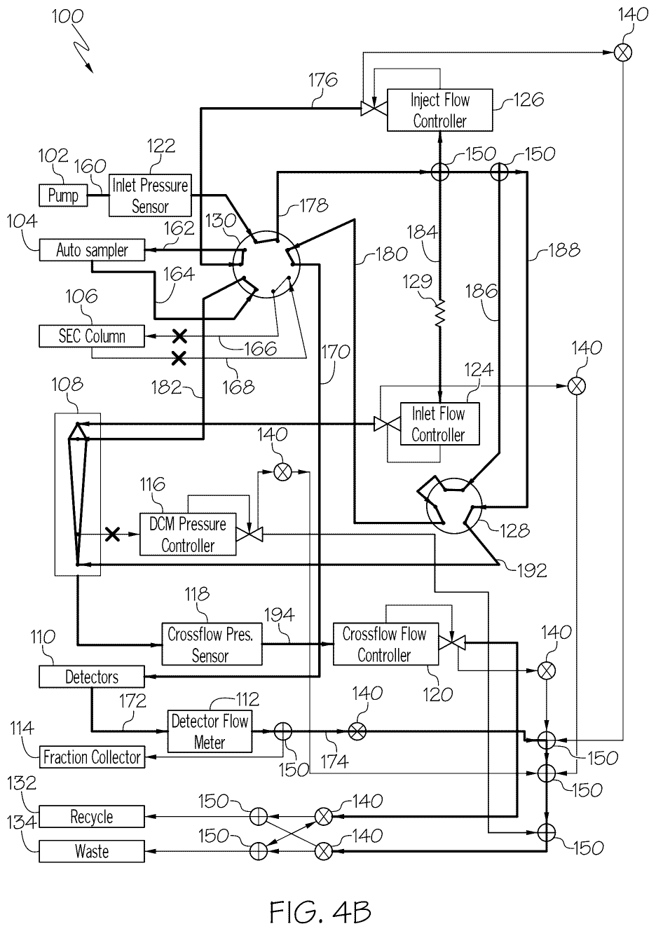

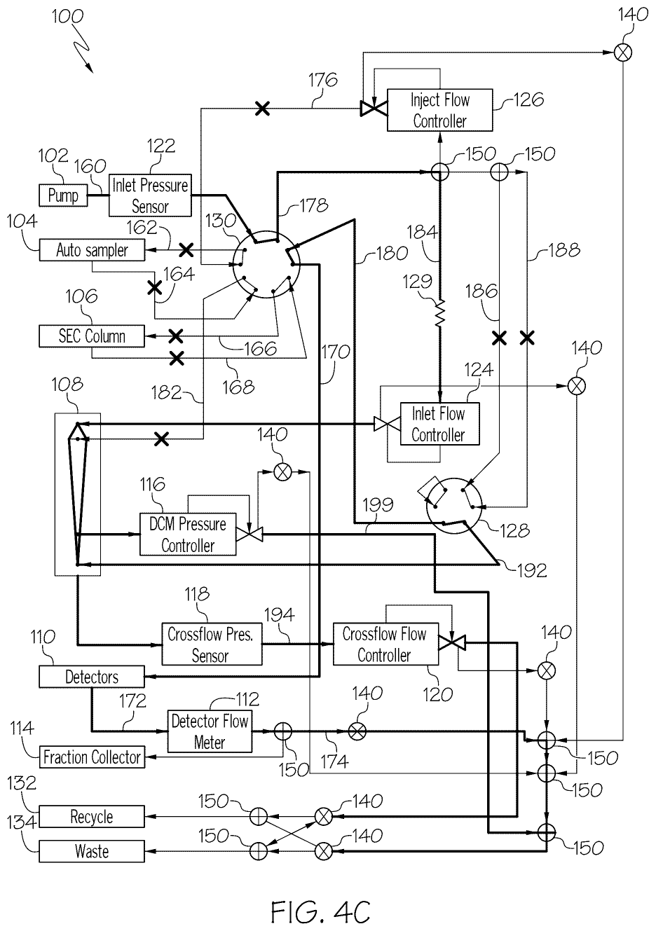

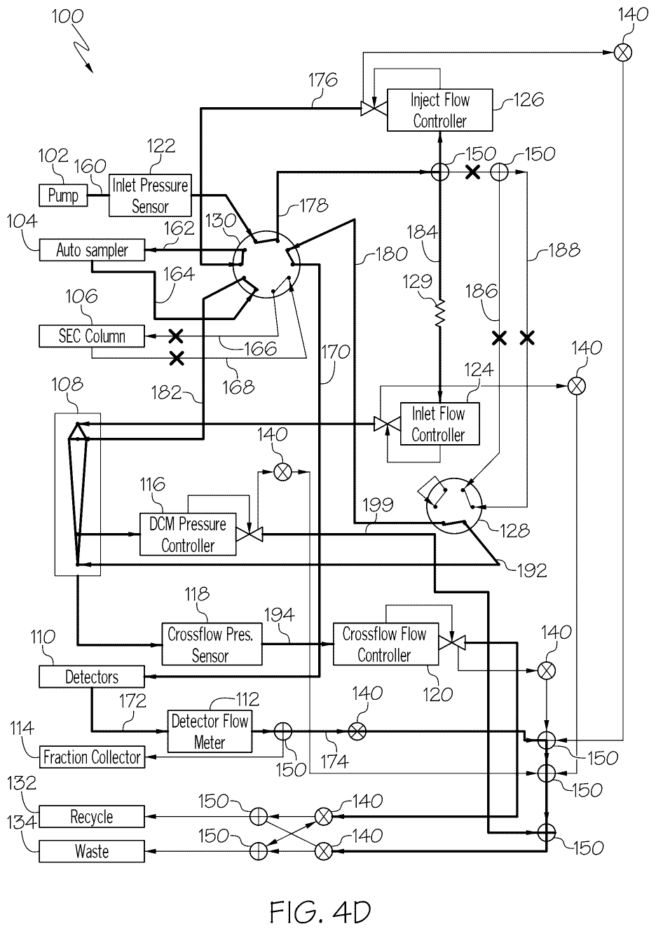

The 10-port rotary switching valve 130 and/or the 6-port rotary switching valve 128 provides for a switching system for switching between the SEC mode shown in FIG. 2, and a FFF mode (described hereinbelow and shown in FIGS. 4A-4D). As shown in FIG. 2, during the SEC mode in which the SEC column 106 is active, the various pressure-sensitive components of the FFF system are fluidically isolated and not subject to the channel pressure of the highlighted SEC mode fluidic pathway. In particular, the inject flow controller 126, the inlet flow controller 124, and the FFF cross flow controller 120, as well as the FFF dilution pressure controller 116, and the FFF cross flow pressure sensor 118 are each isolated and not subject to the pressure of the SEC mode as a result of the various flow paths 176, 178, 180, 182 being isolated and not pressurized.

One or each of the inject flow controller 126, the inlet flow controller 124, the FFF cross flow controller 120, the FFF dilution pressure controller 116, and the FFF cross flow pressure sensor 118 may be considered mass flow controllers and may include a Coriolis flow meter and/or a proportional control valve. For example, one or all of the flow controllers and/or sensors 126, 124, 120, 116, 118 may be Bronkhorst® CORI-FLOW™ Mass Flow Meters and Controllers. In the embodiment shown, the FFF dilution pressure controller 116 is not a Coriolis flow meter, but rather a pressure controller that includes an internal pressure sensor and a controlled proportional valve.

Because of the isolation, the SEC mode of the FFF and SEC system 100, including the fluidic pathway highlighted in FIG. 2, may be configured to operate at pressures above 150 bar without damaging the pressure-sensitive components of the FFF portion of the system. In some embodiments, the SEC mode may be configured to operate up to at least 400 bar pressure without damaging the pressure-sensitive components of the FFF system.

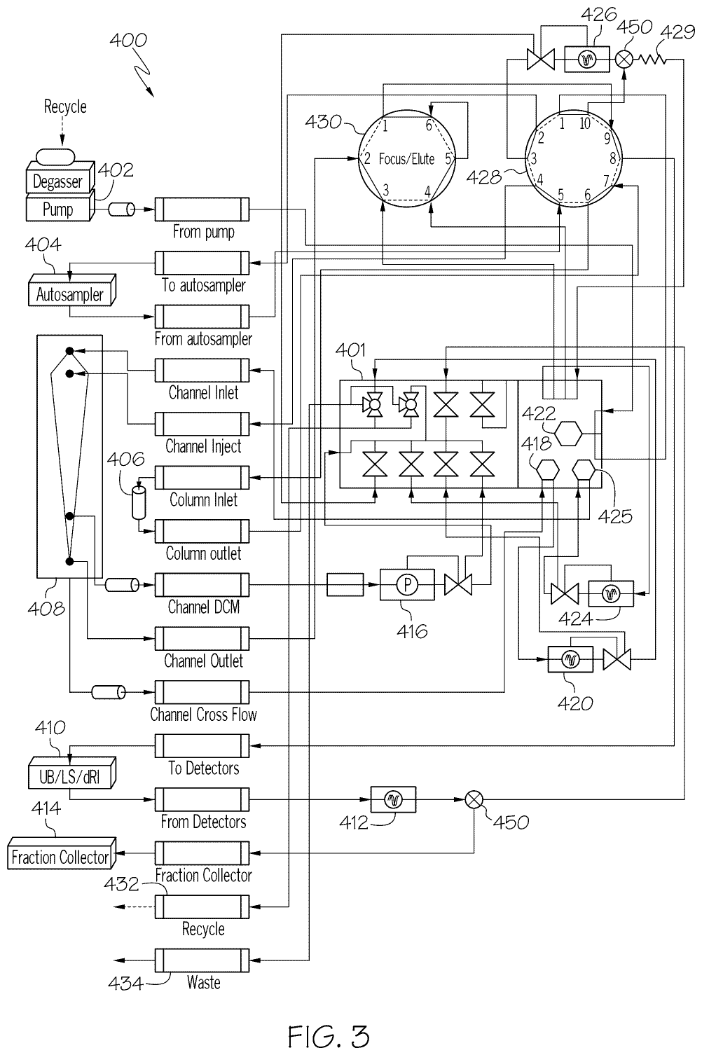

FIG. 3 depicts a schematic fluidic diagram of another field flow fractionation (FFF) and size-exclusion chromatography (SEC) system 400 having a manifold apparatus 401, in accordance with one embodiment. The FFF and SEC system 400 is configured to work the exact same as the SEC system 100 described hereinabove. However, the rather than the extensive plumbing shown with many of the unions 150 and control valves 140, the manifold apparatus 401 simplifies the plumbing by incorporating these unions and control valves therein. Thus, the manifold apparatus 401 is a prefabricated structure that can be incorporated into the FFF and SEC system 400 to simplify assembly and eliminate leak points. The manifold 401 further incorporates various pressure sensors, including an inlet pressure sensor 422, a FFF cross flow pressure controller 418 and a channel pressure sensor 425. The inlet pressure sensor 422 may be operably connected to a control system (e.g., a computer system) further comprising a control system that is configured to stop the pump 402 if the inlet pressure sensor 422 detects over-pressure.

The FFF and SEC system 400 is functionally equivalent to the FFF and SEC system 100 shown in FIGS. 1-2 and 4A-4D. As such, the FFF and SEC system 400 is shown including a pump system 402, an auto sampler 404, an SEC column 406, a field flow fractionator 408, one or more detectors 410, a detector flow meter 412, and a fraction collector 414. Still further, the FFF and SEC system 400 includes an FFF dilution pressure controller 416, the FFF cross flow pressure controller 418, the FFF cross flow controller 420, and the channel pressure sensor 425. The system 400 further includes an inlet pressure sensor 422, an inlet flow controller 424, and an inject flow controller 426. Still further, the FFF and SEC system 400 includes the 6-port rotary switching FFF focus/elute valve 428 (like the 6-port rotary switching FFF focus/elute valve 128 of FIGS. 1-2).

In addition, the FFF and SEC system 400 includes a 10-port rotary switching valve 430 which functions the same as the 10-port rotary switching valve 130 described herein above. In particular, the 10-port rotary switching valve 430 is configured to isolate the pressure sensitive components during the higher-pressure SEC mode, as described herein above, including the inject flow controller 426, the inlet flow controller 424, the FFF dilution pressure controller 416, the crossflow controller 420. Moreover, the FFF and SEC system 400 includes a recycle fluid path 432 and a waste fluid path 434. Due to the manifold 401, the FFF and SEC system 400 only includes only two unions 450—one outside the manifold 401 and the other in front of the inject flow controller 426. The previously shown external unions in FIG. 2 are incorporated into the manifold 401 in this embodiment. Further, the FFF and SEC system 400 includes impedance tubing 429 located proximate the inject flow controller 426. The impedance tubing 429 may be configured to generate injection pressure and to drive a sample from a mass flow controller (i.e. the inject flow controller 426) to the autosampler 404 in FFF mode.

Referring back to the embodiment shown in FIGS. 1-2, FIGS. 4A-4D show the FFF and SEC system 100 in various FFF modes achieved by switching the 10-port rotary switching valve 130 and the 6-port rotary switching valve 128. While not shown it should be understood that the FFF and SEC system 400 operates in the exact same manner as the FFF and SEC system 100, and functionally includes the same exact FFF states as those shown in FIGS. 4A-4D.

FIG. 4A depicts a schematic fluidic diagram of the FFF and SEC system 100 of FIG. 1 in FFF focus mode, in accordance with one embodiment. In FFF focus mode, the 10-port rotary switching valve 130 has been switched or rotated relative to the position shown in FIG. 2. In this mode, the fluidic channels 160, 170, 172, 174, 178, 179, 180, 184, 186, 188, 190, 192, 194, 196 remain open and subject to solvent flow. In FFF focus mode, a sample has not yet been introduced into the system, and the autosampler 104 and accompanying fluid channel 162 are not subject to fluid flow because the inject flow controller 126 does not allow fluid flow therethrough in FFF focus mode. As such, fluidic channels 176, 162, 164 each do not contain fluid flow. This is denoted with an ‘X’ symbol in the Figures. Still further, the SEC column 106 is isolated in this mode, including the fluidic channels 166, 168. Moreover, the FFF dilution pressure controller 116 is also not operable in this state, thereby preventing fluid flow through fluidic channel 198. During focusing mode, the flow is split into two parts which enter from both ends into the field flow fractionator channel 108. The flow rate of the inlet (top) port of the field flow fractionator channel 108 is measured with a flow meter and/or the inlet flow controller 124 in real time and regulated by the inlet flow controller 124 to a certain, defined value, through which the flow rate entering at the outlet (bottom) port and through fluidic channel 192 is automatically determined. The ratio of the two focusing flow rates can be adjusted and this will adjust the focusing zone at a desired position within the field flow fractionator channel 108.

FIG. 4B depicts a schematic fluidic diagram of the FFF and SEC system 100 of FIGS. 1 and 2 in FFF focus mode during injection, in accordance with one embodiment. During injection, the inject flow controller 126 opens in order to provide fluid and/or solvent to the autosampler 104 through fluidic channels 176, 162. The sample and solvent combination is thereafter provided to the 10-port rotary switching valve 130 via fluidic channel 164, and then to the field flow fractionator channel 108 via the fluidic channel 182. In this mode of FFF, the SEC column 106 remains isolated and not in use. Further, the FFF dilution pressure controller 116 is also not operable in this state, thereby preventing fluid flow through the fluidic channel 198.

FIG. 4C depicts a schematic fluidic diagram of the FFF and SEC system of FIGS. 1-3 in FFF elution mode with dilution control, in accordance with one embodiment. During elution, the second 6-port rotary FFF focus/elute valve 128 has been switched in order to allow the fractionated sample exiting the field flow fractionator channel 108 through fluidic channel 192 to travel through fluidic channel 180 to the 10-port rotary switching valve 130, and then to the detector 110 via the fluidic channel 170. In this mode, the FFF dilution pressure controller 116 is operable, thereby allowing fluid flow through the fluidic channel 198. However, injection is not occurring in this mode, so the autosampler 104 is isolated along with fluidic channels 162, 164, in addition to the injection pathway 182 connecting the autosampler 104 to the field flow fractionator channel 108.

FIG. 4D depicts a schematic fluidic diagram of the FFF and SEC system of FIGS. 1-4 in FFF elution mode during injection with dilution control, in accordance with one embodiment. During the combination of elution and injection with dilution control, the fluidic channels to and from the autosampler 104 remain open, and the autosampler 104 remains connected to the field flow fractionator channel 108 via the injection pathway 182. In addition, the second 6-port rotary FFF focus/elute valve 128 has been switched in order to allow the fractionated sample exiting the field flow fractionator channel 108 through fluidic channel 192 to travel through fluidic channel 180 to the 10-port rotary switching valve 130, and then to the detector 110 via the fluidic channel 170. In this mode, the FFF dilution pressure controller 116 is operable, thereby allowing fluid flow through the fluidic channel 198.

Various methods of performing FFF and/or SEC are also contemplated herein. For example, a fractionation method is contemplated which includes providing a fractionation system (such as one of the exemplary systems 100, 200, 300) including a solvent delivery system (such as one of the pump systems 102, 202, 302), a sample delivery system (such as one of the auto samplers 104, 204, 304), a field flow fractionation (FFF) system including pressure-sensitive components (such as the inject flow controllers 126, 226, 326, the inlet flow controllers 124, 224, 324, the FFF cross flow controller 120, 220, 320, the FFF dilution pressure controller 116, 216, 316, and the FFF cross flow pressure controller and/or sensor 118, 218, 318), and a FFF channel (such as one of the FFF channels 108, 208, 308), a size exclusion chromatography (SEC) system including a chromatography column (such as one of the SEC columns 106, 206, 306), and a switching system (such as one of the pairs of rotary switching valves, 128 and 130, 228 and 230, or 328 and 330).

Methods contemplated may include switching, by the switching system, between a field flow fractionation (FFF) mode in which the FFF channel is active to a size exclusion chromatography (SEC) mode in which the chromatography column is active, and fluidically isolating the pressure-sensitive components of the FFF system during the SEC mode.

Methods may further include operating above 150 bar pressure without damaging the pressure-sensitive components of the FFF system during the SEC mode. Methods may even include operating up to at least 400 bar pressure without damaging the pressure-sensitive components of the FFF system during the SEC mode.

Methods may further include switching between the FFF mode and the SEC mode with the 10-port rotary switching valve, and include switching between a focus mode and an elute mode during the FFF mode with a 6-port rotary switching valve.

Methods may still further include generating pressure that pushes a sample from a mass flow controller to the autosampler in FFF mode with impedance tubing.

In some embodiments, the chromatography column may be a high-performance HPLC or SEC column. In such embodiments, methods contemplated herein may include separating a sample through the high-performance columns at pressures over 75 bar in SEC mode. Methods may include separating a sample through the high-performance columns at pressures over 100 bar in SEC mode, or over 200 bar, or over 300 bar, or even at or above 400 bar or more while isolating pressure-sensitive components of the FFF system.

This disclosure describes an improved plumbing system that allows the current low pressure switching instrument, to increase the SEC pressure limit from 75 bar to 400 bar or more. This allows for the use of a wide range of high-performance SEC columns that were previously not usable with this instrument.

While various examples have been shown and described, the description is intended to be exemplary, rather than limiting and it should be understood by those of ordinary skill in the art that various changes in form and detail may be made therein without departing from the scope of the invention as recited in the accompanying claims.

1. A fractionation system, comprising:
a solvent delivery system;
a sample delivery system;
a field flow fractionation (FFF) system including pressure-sensitive components and a FFF channel, the FFF channel fluidically connected to the sample delivery system and the solvent delivery system;
a size exclusion chromatography (SEC) system including a chromatography column, the chromatography column fluidically connected to the sample delivery system and the solvent delivery system; and
a switching system for switching between a field flow fractionation (FFF) mode in which the FFF channel is active to a size exclusion chromatography (SEC) mode in which the chromatography column is active, wherein the pressure-sensitive components of the FFF system are fluidically isolated during the SEC mode.

2. The fractionation system of claim 1, wherein the SEC mode is configured to operate above 150 bar pressure without damaging the pressure-sensitive components of the FFF system.

3. The fractionation system of claim 2, wherein the SEC mode is configured to operate up to at least 400 bar pressure without damaging the pressure-sensitive components of the FFF system.

4. The fractionation system of claim 1, wherein the switching system includes a 10 port rotary switching valve.

5. The fractionation system of claim 4, wherein the 10-port rotary switching valve is fluidically coupled to a manifold.

6. The fractionation system of claim 5, further comprising a 6-port rotary switching valve fluidically coupled to the manifold and the 10-port rotary switching valve.

7. The fractionation system of claim 6, wherein a first of the 6-port rotary switching valve and the 10-port rotary switching valve is configured to switch between the FFF mode and the SEC mode, and wherein a second of the 6-port rotary switching valve and the 10-port rotary switching valve is configured to switch between a focus mode and an elute mode during the FFF mode.

8. The fractionation system of claim 1, further comprising an inlet pressure sensor coupled to the solvent delivery system.

9. The fractionation system of claim 1, wherein the pressure-sensitive components include at least one flow controller.

10. The fractionation system of claim 9, wherein the at least one flow controller includes a Coriolis flow meter and a proportional control valve.

11. The fractionation system of claim 1, wherein the sample delivery is an autosampler, and wherein the switching system includes impedance tubing configured to drive a sample from a mass flow controller to the autosampler in FFF mode.

12. A fractionation method comprising:
providing a fractionation system including a solvent delivery system, a sample delivery system, a field flow fractionation (FFF) system including pressure-sensitive components and a FFF channel, a size exclusion chromatography (SEC) system including a chromatography column, and a switching system;
switching, by the switching system, between a field flow fractionation (FFF) mode in which the FFF channel is active to a size exclusion chromatography (SEC) mode in which the chromatography column is active; and
fluidically isolating the pressure-sensitive components of the FFF system during the SEC mode.

13. The fractionation method of claim 12, further comprising operating above 150 bar pressure without damaging the pressure-sensitive components of the FFF system during the SEC mode.

14. The fractionation method of claim 12, further comprising operating up to at least 400 bar pressure without damaging the pressure-sensitive components of the FFF system during the SEC mode.

15. The fractionation method of claim 12, wherein the switching system includes a 10-port rotary switching valve and a 6-port rotary switching valve, the method further comprising:
switching between a the FFF mode and the SEC mode with the 10-port rotary switching valve.

16. The fractionation method of claim 15, further comprising switching between a focus mode and an elute mode during the FFF mode with the 6-port rotary switching valve.

17. The fractionation method of claim 12, wherein the sample delivery is an autosampler, the method further comprising generating a pressure that pushes a sample from a mass flow controller to the autosampler in FFF mode with impedance tubing.

18. The fractionation method of claim 12, wherein the chromatography column is a high performance column, the method further comprising separating a sample through the high performance columns at pressures over 75 bar in SEC mode.

19. A fractionation system comprising:
a switching valve system including a 10-port rotary switching valve and a 6-port rotary switch valve, wherein the switching valve system is coupled to a switch actuator for a field flow fractionator (FFF) system in order to isolate pressure-sensitive components of the FFF system in a high-pressure liquid chromatography (HPLC) mode, wherein the switching system further includes impedance tubing to drive a sample from an autosampler in an FFF mode;
a manifold coupled to the switching valve system; and
a union coupled to the switching valve system and the manifold,
wherein the switching valve system, the manifold, the union, and the switch actuator enable separating the sample through high performance columns at pressures over 75 bar in HPLC mode.

20. The fractionation system of claim 19, further comprising:
a pump; and
an inlet pressure sensor coupled to the switching valve system and the pump.

21. The fractionation system of claim 20, further comprising a control system, wherein the control system is configured to stop the pump if the inlet pressure sensor detects over-pressure.
